(19) United States
(12) Patent Application Publication
(10) Pub. No.: US 2012/0218383 A1
(43) Pub. Date: Aug. 30, 2012

(54) VIDEO OUTPUT APPARATUS AND VIDEO OUTPUT METHOD

(75) Inventor: Takuya Shiki, Fukaya-shi (JP)

(73) Assignee: KABUSHIKI KAISHA TOSHIBA, Tokyo (JP)

(21) Appl. No.: 13/291,409

(22) Filed: Nov. 8, 2011

(30) Foreign Application Priority Data
Feb. 28, 2011 (JP) 2011-042818

(51) Int. Cl. H04N 13/00

(52) U.S. Cl. 348/43; 348/E13.064

(57) ABSTRACT

According to one embodiment, a video output apparatus includes an input module, an output module, and a transmitter. The input module is configured to input a 2D content and a 3D content. The output module is configured to alternately output a first image and a second image required to display images having a parallax at image output timings based on the 3D content, and to repetitively output 2D content images at the image output timings based on the 2D content. The transmitter is configured to transmit, to 3D image glasses which open and close a right-eye shutter and a left-eye shutter, timing control signals, which indicate open/close timings of the right-eye shutter and the left-eye shutter in synchronism with the image output timings of the output module, for both the 2D content and the 3D content.

### CROSS-REFERENCE TO RELATED APPLICATIONS

This application is based upon and claims the benefit of priority from prior Japanese Patent Application No. 2011-042818, filed Feb. 28, 2011, the entire contents of which are incorporated herein by reference.

### FIELD

Embodiments described herein relate generally to a video output apparatus and video output method.

### BACKGROUND

In recent years, three-dimensional (3D) video playback apparatuses such as digital televisions, which are compatible with 3D images, have begun to prevail. Also, digital cameras which can record 3D still images or digital video cameras which can record 3D moving images have also begun to prevail.

For example, the aforementioned 3D video playback apparatus can play back a 3D image program provided by a broadcast signal, a 3D still image recorded by, for example, a digital camera, and a 3D moving image recorded by, for example, a digital video camera.

Also, the aforementioned 3D video playback apparatus can also play back two-dimensional (2D) image programs, 2D still images, and 2D moving images as heretofore.

From this situation, it is demanded that the user wants to randomly play back 3D content such as 3D image programs, 3D still images, and 3D moving images and 2D content such as 2D image programs, 2D still images, and 2D moving images in the aforementioned 3D video playback apparatus.

For example, when the 3D video playback apparatus plays back a 3D content, the user can view the 3D content by putting on 3D glasses compatible with the 3D content. When the 3D video playback apparatus plays back a 2D content, the user can view the 2D content by taking off the 3D glasses.

When the 3D video playback apparatus randomly plays back 3D and 2D content, it is inconvenient for the user since he or she has to put on the 3D glasses and to take them off.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a schematic block diagram showing an example of the arrangement of a digital television broadcast receiver (video output apparatus) according to respective embodiments;

FIG. 2 is a view showing an example of a content list display screen according to the first embodiment;

FIG. 3 is a flowchart showing an example of video output control according to the first embodiment; and

FIG. 4 is a view for explaining an example of the video output control according to the first embodiment.

### DETAILED DESCRIPTION

Various embodiments will be described hereinafter with reference to the accompanying drawings.

In general, according to one embodiment, a video output apparatus includes an input module, an output module, and a transmitter. The input module is configured to input a 2D content and a 3D content. The output module is configured to alternately output a first image and a second image required to display images having a parallax at image output timings based on the 3D content, and to repetitively output 2D content images at the image output timings based on the 2D content. The transmitter is configured to transmit, to 3D image glasses which open and close a right-eye shutter and a left-eye shutter, timing control signals, which indicate open/close timings of the right-eye shutter and the left-eye shutter in synchronism with the image output timings of the output module, for both the 2D content and the 3D content.

Respective embodiments will be described hereinafter with reference to the drawings.

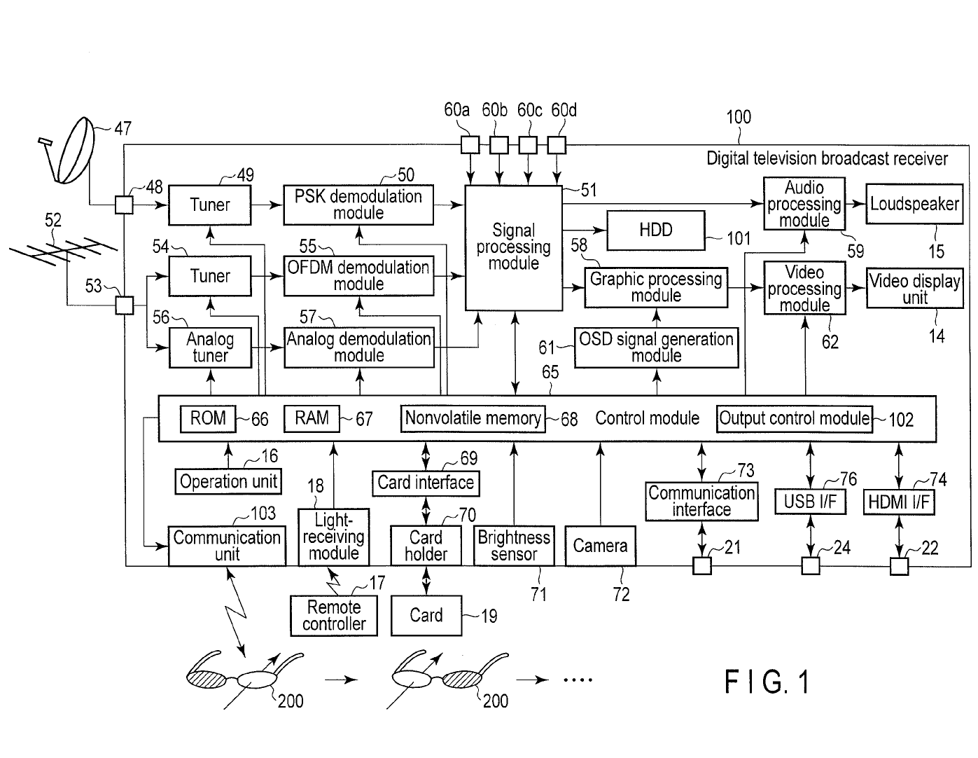

FIG. 1 is a schematic block diagram showing an example of the arrangement of a digital television broadcast receiver (video output apparatus) according to respective embodiments. Note that the digital television broadcast receiver shown in FIG. 1 is a 3D video processing apparatus which is compatible with 3D (3-dimensional) images.

For example, the digital television broadcast receiver can receive a broadcast signal containing a 3D image program and that containing a 2D image program, can record the 3D and 2D image programs, and can play back (display) the 3D and 2D image programs.

The digital television broadcast receiver can connect a digital camera via, for example, a USB terminal, can receive 3D and 2D still images recorded by the digital camera, can record the 3D and 2D still images, and can play back (display) the 3D and 2D still images.

Furthermore, the digital television broadcast receiver can connect a digital video camera via, for example, a USB terminal, can receive 3D and 2D moving images recorded by the digital video camera, can record the 3D and 2D moving images, and can play back (display) the 3D and 2D moving images.

That is, the digital television broadcast receiver can process a 3D image program, 3D still image, and 3D moving image (collectively referred as 3D content hereinafter), and can also process a 2D image program, 2D still image, and 2D moving image (collectively referred to as 2D content hereinafter).

Respective embodiments will explain video output control by the digital television broadcast receiver. However, the video output control of each embodiment is not limited to that by the digital television broadcast receiver. The video output control to be described below can also be implemented by various recorders and players which are compatible with 3D image processing and 2D image processing.

A digital television broadcast receiver 100 will be described below with reference to FIG. 1. As shown in FIG. 1, a satellite digital television broadcast signal, which is received by a BS/CS digital broadcast receiving antenna 47, is supplied to a satellite digital broadcast tuner 49 via an input terminal 48, and the tuner 49 tunes in a broadcast signal of a designated channel.

The broadcast signal tuned in by this tuner 49 is supplied to a phase-shift keying (PSK) demodulation module 50, and is demodulated to obtain a digital video signal and audio signal, which are then output to a signal processing module 51.

A terrestrial digital television broadcast signal, which is received by a terrestrial broadcast receiving antenna 52, is supplied to a terrestrial digital broadcast tuner 54 via an input terminal 53, and the tuner 54 tunes in a broadcast signal of a designated channel.

The broadcast signal tuned in by this tuner 54 is supplied to an orthogonal frequency division multiplexing (OFDM) demodulation module 55, and is demodulated to obtain a digital video signal and audio signal, which are then output to the signal processing module 51.

A terrestrial analog television broadcast signal, which is received by the terrestrial broadcast receiving antenna 52, is supplied to a terrestrial analog broadcast tuner 56 via the input terminal 53, and the tuner 56 tunes in a broadcast signal of a designated channel. The broadcast signal tuned in by this tuner 56 is supplied to an analog demodulation module 57, and is demodulated to obtain an analog video signal and audio signal, which are then output to the signal processing module 51.

The signal processing module 51 selectively applies predetermined digital signal processing to the digital video and audio signals respectively supplied from the PSK demodulation module 50 and OFDM demodulation module 55, and outputs the processed signals to a graphic processing module 58 and audio processing module 59.

To the signal processing module 51, a plurality (four in FIG. 1) of input terminals 60a, 60b, 60c, and 60d are connected. These input terminals 60a to 60d allow to respectively input analog video and audio signals from a device outside the digital television broadcast receiver 100.

The signal processing module 51 selectively converts the analog video and audio signals respectively supplied from the analog demodulation module 57 and input terminals 60a to 60d into digital video and audio signals, applies predetermined digital signal processing to the digital video and audio signals, and then outputs these signals to the graphic processing module 58 and audio processing module 59.

Of these processing modules, the graphic processing module 58 has a function of superimposing an on-screen display (OSD) signal generated by an OSD signal generation module 61 on the digital video signal supplied from the signal processing module 51, and outputting that signal. This graphic processing module 58 can selectively output the output video signal of the signal processing module 51 and the output OSD signal of the OSD signal generation module 61, or can combine and output these outputs.

The digital video signal output from the graphic processing module 58 is supplied to a video processing module 62. The video signal processed by the video processing module 62 is supplied to a video display unit 14, and also to an output terminal 63. The video display unit 14 displays an image based on the video signal. When an external device is connected to the output terminal 63, the video signal supplied to the output terminal 63 is input to the external device.

The audio processing module 59 converts the input digital audio signal into an analog audio signal which can be played back by a loudspeakers 15, and outputs the analog audio signal to the loudspeakers 15 to output a sound and also externally outputs it via an output terminal 64.

Note that a control module 65 of the digital television broadcast receiver 100 integrally controls all processes and operations including the aforementioned signal processes and the like. The control module 65 is configured by a central processing unit (CPU) and the like. The control module 65 controls respective modules based on operation information from an operation unit 16 or that which is output from a remote controller 17 and is received by a light-receiving unit 18, so as to reflect the nature of the operation.

In this case, the control module 65 mainly uses a read-only memory (ROM) 66 which stores control programs executed by the CPU, a random access memory (RAM) 67 which provides a work area to the CPU, and a nonvolatile memory 68 which stores various kinds of setting information, control information, and the like.

This control module 65 is connected to a card holder 70, which can receive a memory card 19, via a card interface 69. Thus, the control module 65 can exchange, via the card interface 69, information with the memory card 19 attached to the card holder 70.

Also, the control module 65 is connected to a LAN terminal 21 via a communication interface 73. Thus, the control module 65 can exchange information via a LAN cable connected to the LAN terminal 21 and the communication interface 73. For example, the control module 65 can receive a content delivered from a server via the LAN cable and communication interface 73.

Furthermore, the control module 65 is connected to an HDMI terminal 22 via an HDMI interface 74. Thus, the control module 65 can exchange, via the HDMI interface 74, information with HDMI-compatible devices connected to the HDMI terminal 22.

Moreover, the control module 65 is connected to a USB terminal 24 via a USB interface 76. Thus, the control module 65 can exchange, via the USB interface 76, information with USB-compatible devices (such as a digital camera and digital video camera) connected to the USB terminal 24.

In addition, the control module 65 refers to video recording reservation information included in a video recording reservation list stored in the nonvolatile memory 68, and controls a video recording operation of a content based on a reception signal. As a video recording destination, for example, a built-in HDD 101 is available.

Also, the control module 65 controls the brightness of a backlight of the video display unit 14 based on a brightness detection level from a brightness sensor 71. The control module 65 controls ON/OFF of an image on the video display unit 14 by determining the presence/absence of a user at an opposing position of the video display unit 14 based on moving image information from a camera 72.

The control module 65 includes an output control module 102, and the control module 65 and output control module 102 execute video output control to be described later.

Next, an example of the video output control by the digital television broadcast receiver 100 (control module 65 and output control module 102) will be described below.

### First Embodiment

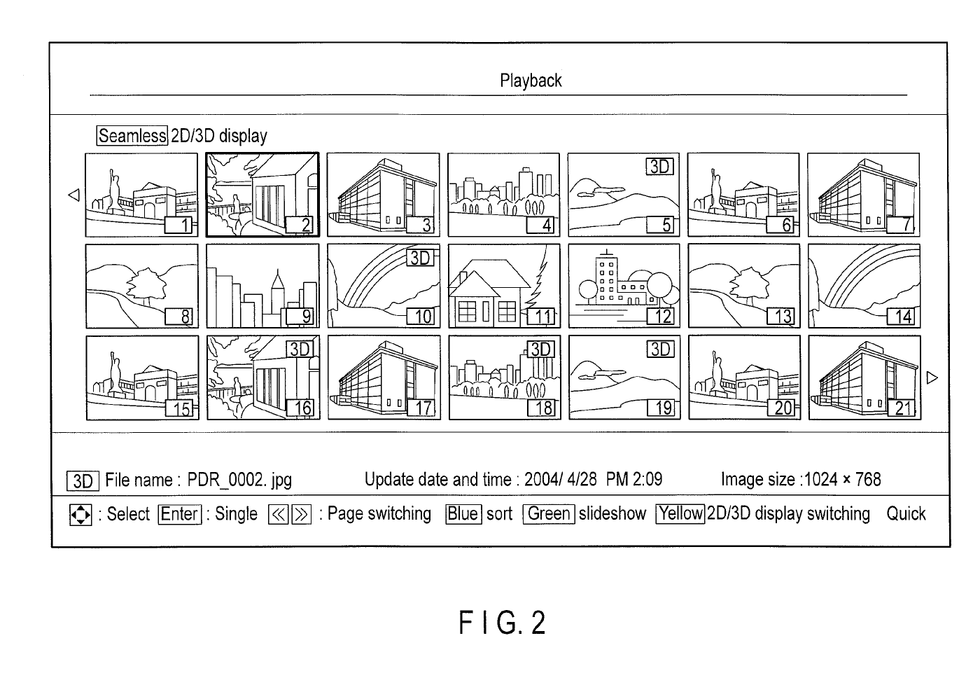

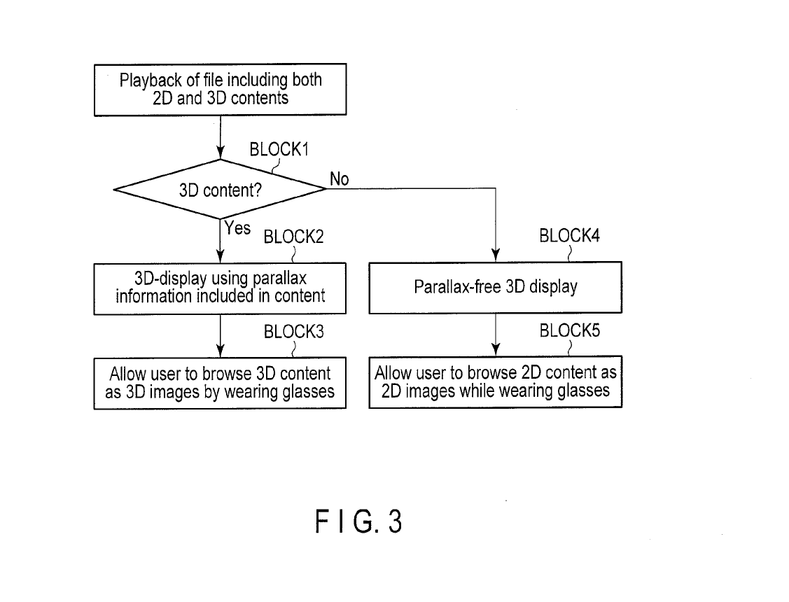

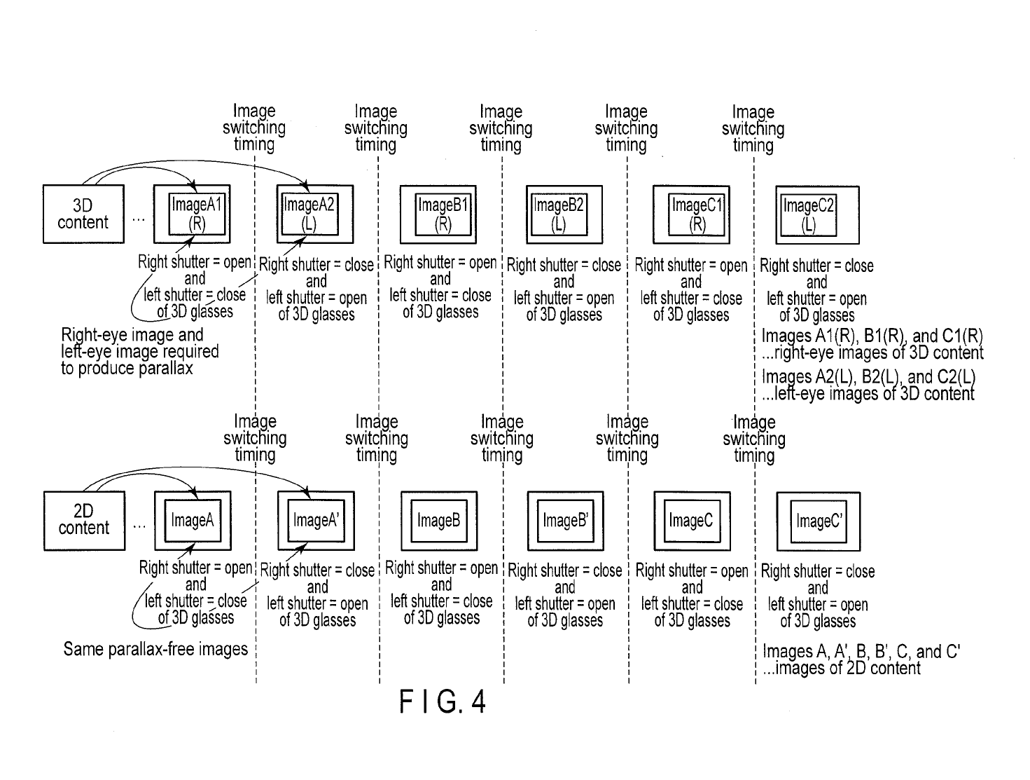

The first embodiment will be described below with reference to FIGS. 2, 3, and 4. FIG. 2 is a view showing an example of a content list display screen according to the first embodiment. FIG. 3 is a flowchart showing an example of the video output control according to the first embodiment. FIG. 4 is a view for explaining an example of the video output control according to the first embodiment.

For example, a case will be assumed wherein the HDD 101 of the digital television broadcast receiver saves 2D content (at least one of a 2D still image [for example, a JPEG image] and a 2D moving image [for example, an MPEG image]) and 3D content (3D still image [stereoscopic viewing images of an MP format] and 3D moving image). Note that the 2D and 3D content is that which is input via input modules such as the input terminals 48 and 53, communication interface 73, HDMI interface 74, and USB interface 76.

For example, the user who wants to play back a content, inputs a content playback instruction via the operation unit 16 or remote controller 17. In response to this instruction, the control module 65 and output control module 102 execute control required to display a content list display screen. In response to this control, the graphic processing module 58, OSD signal generation module 61, and video processing module 62 output display information required to display the content list display screen. In response to this information, the video display unit 14 displays, for example, the content list display screen shown in FIG. 2. For example, the content list display screen includes thumbnail images corresponding to content saved on the HDD 101.

For example, the user can select a desired thumbnail image (first thumbnail image) in the content list display screen via the operation unit 16 or remote controller 17, and can designate a time-series automatic playback mode (for example, a slideshow). In response to this operation, the control module 65 and output control module 102 control playback of a first content (2D or 3D content) corresponding to the first thumbnail image, control that of a second content (2D or 3D content) which is newest next to the first content, and control that of a third content (2D or 3D content) which is newest next to the second content. Each content includes recording date and time information (capturing date and time information), and the control module 65 and output control module 102 decide the playback order based on the recording date and time information of the respective content.

When the first content is a 3D content (3D still image content or 3D moving image content) (YES in BLOCK 1), the control module 65 and output control module 102 instruct to 3D-output (3D-display) the first content.

In response to the 3D-output instruction, the video processing module 62 outputs images required to 3D-output (3D-display) the first content based on parallax information included in the first content, and the video display unit 14 3D-outputs (3D-displays) the first content (BLOCK 2).

For example, as shown in FIG. 4, based on the first content (3D content), the video processing module 62 outputs an image A1(R) to be displayed at a right-eye display position, switches image A1(R) to an image A2(L) to be displayed at a left-eye display position and outputs image A2(L) at an image switching timing (image output timing), switches image A2(L) to an image B1(R) to be displayed at the right-eye display position and outputs image B1(R) at the next image switching timing, switches image B1(R) to an image B2(L) to be displayed at the left-eye display position and outputs image B2(L) at the next image switching timing, switches image B2(L) to an image C1(R) to be displayed at the right-eye display position and outputs image C1(R) at the next image switching timing, and switches image C1(R) to an image C2(L) to be displayed at the left-eye display position and outputs image C2(L) at the next image switching timing. Note that images A1 and A2 are substantially the same images, images B1 and B2 are substantially the same images, and images C1 and C2 are substantially the same images.

As described above, the video processing module 62 alternately outputs a first image (R or L) and second image (L or R) required to display images having a parallax at image output timings based on the first content (3D content). Furthermore, the first image is that to be displayed at the right-eye display position, and the second image is that to be displayed at the left-eye display position. That is, the display position of the first image is different from that of the second image.

Also, in response to the 3D-output instruction, a communication unit 103 transmits timing control signals synchronized with the image switching timings (image output timings). 3D glasses 200 receive the timing control signals, and control open/close timings of a right-eye shutter and left-eye shutter based on the timing control signals. For example, as shown in FIG. 4, the right-eye shutter of the 3D glasses 200 is opened and the left-eye shutter is closed in response to the output of image A1(R), the right-eye shutter of the 3D glasses 200 is closed and the left-eye shutter is opened in response to the output of image A2(L), the right-eye shutter of the 3D glasses 200 is opened and the left-eye shutter is closed in response to the output of image B1(R), the right-eye shutter of the 3D glasses 200 is closed and the left-eye shutter is opened in response to the output of image B2(L), the right-eye shutter of the 3D glasses 200 is opened and the left-eye shutter is closed in response to the output of image C1(R), and the right-eye shutter of the 3D glasses 200 is closed and the left-eye shutter is opened in response to the output of image C2(L).

With the above control, a parallax is produced by images A1(R) and A2(L), a parallax is produced by images B1(R) and B2(L), and a parallax is produced by images C1(R) and C2(L). Then, the user who wears the 3D glasses 200 can view the first content as 3D images (BLOCK 3).

When the first content is a 2D content (2D still image content or 2D moving image content) (NO in BLOCK 1), the control module 65 and output control module 102 instruct to parallax-free 3D-output (parallax-free 3D-display) the first content.

In response to the parallax-free 3D-output instruction, based on the first content, the video processing module 62 outputs images required to parallax-free 3D-output (parallax-free 3D-display) the first content, and the video display unit 14 parallax-free 3D-outputs (parallax-free 3D-displays) the first content (BLOCK 4).

For example, as shown in FIG. 4, based on the first content (2D content), the video processing module 62 outputs an image A, switches image A to an image A′ and outputs image A′ at an image switching timing (image output timing), switches image A′ to an image B and outputs image B at the next image switching timing, switches image B to an image B′ and outputs image B′ at the next image switching timing, switches image B′ to an image C and outputs image C at the next image switching timing, and switches image C to an image C′ and outputs image C′ at the next image switching timing. Note that images A and A′ are substantially identical images, images B and B′ are substantially identical images, and images C and C′ are substantially identical images.

As described above, the video processing module 62 repetitively outputs the 2D content images required to display parallax-free images at the image output timings based on the first content (2D content). Furthermore, the 2D content images to be repetitively output are those which are displayed at a reference display position. That is, the 2D content images to be repetitively output are displayed at the same display position.

Also, in response to the parallax-free 3D-output instruction, the communication unit 103 transmits timing control signals synchronized with the image switching timings (image output timings). The 3D glasses 200 receive the timing control signals, and control the open/close timings of the right-eye shutter and left-eye shutter based on the timing control signals. For example, as shown in FIG. 4, the right-eye shutter of the 3D glasses 200 is opened and the left-eye shutter is closed in response to the output of image A, the right-eye shutter of the 3D glasses 200 is closed and the left-eye shutter is opened in response to the output of image A′, the right-eye shutter of the 3D glasses 200 is opened and the left-eye shutter is closed in response to the output of image B, the right-eye shutter of the 3D glasses 200 is closed and the left-eye shutter is opened in response to the output of image B′, the right-eye shutter of the 3D glasses 200 is opened and the left-eye shutter is closed in response to the output of image C, and the right-eye shutter of the 3D glasses 200 is closed and the left-eye shutter is opened in response to the output of image C′.

With the above control, images A and A′ produce a parallax-free 3D image, images B and B′ produce a parallax-free 3D image, and images C and C′ produce a parallax-free 3D image. Thus, the user who wears the 3D glasses 200 can view the first content as parallax-free 3D images (2D images) while wearing the 3D glasses 200 (BLOCK 5). In addition, since the shutters are synchronized with the image switching timings, the user can naturally view the first content as constant-luminance images.

### Second Embodiment

The first embodiment has explained the case in which the digital television broadcast receiver automatically plays back 2D and 3D content time-serially. Likewise, the digital television broadcast receiver can also automatically play back 2D and 3D content randomly. In this case as well, as described in the first embodiment, since the digital television broadcast receiver produces a parallax using images A1(R) and A2(L), produces a parallax using images B1(R) and B2(L), and produces a parallax using images C1(R) and C2(L), the user who wears the 3D glasses 200 can view the 3D content as 3D images. Also, upon playback of the 2D content, since the digital television broadcast receiver produces a parallax-free 3D image by images A and A′, produces a parallax-free 3D image by images B and B′, and produces a parallax-free 3D image by images C and C′, the user who wears the 3D glasses 200 can view the 2D content as parallax-free 3D images (2D images) while wearing the 3D glasses 200.

The respective embodiments will be summarized below.

In order to view a 3D content using the digital television broadcast receiver, a special instrument or device such as 3D glasses is used. Upon playing back a file which includes both 2D and 3D content, the digital television broadcast receiver determines whether the content to be played back is a 2D or 3D content. For example, the digital television broadcast receiver determines based on, for example, a data structure or format of the content to be played back whether the content to be played back is a 2D or 3D content. Alternatively, the digital television broadcast receiver determines based on a 3D or 2D flag contained in the content to be played back whether or not the content to be played back is a 2D or 3D content. Alternatively, the digital television broadcast receiver determines based on 3D-related text information (for example, characters such as “3D” or “stereoscopic”) or 2D-related text information (for example, characters such as “2D”) contained in the content to be played back whether or not the content to be played back is a 2D or 3D content.

When the content to be played back is a 3D content, the digital television broadcast receiver displays 3D images using parallax information included in the 3D content. The user can view the 3D content as 3D images by wearing the 3D glasses. Also, when the content to be played back is a 2D content, the digital television broadcast receiver displays the 2D content as parallax-free 3D images. The user can view the 2D content as parallax-free 3D images while wearing the 3D glasses. That is, since the switching timings of display images are synchronized with the open/close switching timings of the right and left shutters of the 3D glasses, the user can view the 2D content as parallax-free 3D images while wearing the 3D glasses. With such synchronization, the user can view the 2D content as constant-brightness images which do not suffer any luminance change in the same manner as in viewing of the 3D content.

With the above control, the digital television broadcast receiver allows the user who wears the 3D glasses to naturally view a 2D photo image (JPEG image) and 3D photo image (stereoscopic viewing images of the MP format) at a constant luminance level. Also, the digital television broadcast receiver allows the user who wears the 3D glasses to naturally view a 2D moving image and 3D moving image at a constant luminance level. Furthermore, the digital television broadcast receiver allows the user who wears the 3D glasses to naturally view a 2D photo image, 3D photo image, 2D moving image, and 3D moving image at a constant luminance level.

Conventionally, upon playing back a file including both 2D and 3D content, for example, since a content display apparatus displays all content as 2D images, the user can smoothly browse all the content without wearing any 3D glasses. That is, the content display apparatus converts the 3D content into a 2D content, and displays the converted 2D content.

Alternatively, upon playing back a file including both 2D and 3D content, for example, since the content display apparatus displays all content as 3D images, the user can smoothly browse all the content while wearing 3D glasses. That is, the content display apparatus converts the 2D content into a 3D content, and displays the converted 3D content.

Alternatively, upon playing back a file including both 2D and 3D content, for example, the content display apparatus displays all 2D content included in the file first, and then displays all 3D content included in the file. Thus, the user views all the 2D content without wearing any 3D glasses, and then views all the 3D content by wearing the 3D glasses. Or the content display apparatus displays all the 3D content included in the file, and then displays all the 2D content included in the file. Thus, the user views all the 3D content by wearing the 3D glasses, and then views all the 2D content by taking off the 3D glasses. In this case, not all the content can be displayed time-serially or randomly. That is, the display order ignores that of content that the user intended.

The digital television broadcast receiver described in the respective embodiments can play back (display) a file including both 2D and 3D content in the content display order that the user intended. That is, the user can view the 3D content as 3D images and can view the 2D content as parallax-free 3D images while wearing the 3D glasses (without putting on or taking off the 3D glasses). In addition, the user can view the 3D and 2D content at a constant luminance level. In this way, the user can comfortably view the 3D and 2D content without any contrast differences.

According to at least one of the aforementioned embodiments, the video output apparatus and video output method, which can randomly output (play back) 3D and 2D content without stressing the user, can be provided.

The various modules of the embodiments described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A video output apparatus comprising:
an input module configured to receive 2D content and 3D content;
an output module configured to display images having a parallax by alternately outputting a first image and a second image at image output timings based on the 3D content, and repetitively outputting 2D content images at the image output timings based on the 2D content; and
a transmitter configured to transmit, to 3D image glasses which open and close a right-eye shutter and a left-eye shutter, timing control signals indicative of open and close timings of the right-eye shutter and the left-eye shutter which synchronize the open and close timings with the image output timings of the output module for both the 2D content and the 3D content.

2. The apparatus of claim 1, wherein the output module is further configured to alternately output the first image and the second image comprising different display positions, and to repetitively output the 2D content images having identical display positions.

3. The apparatus of claim 1, wherein the output module is further configured to alternately output the first image for a right eye and the second image for the left eye, wherein the first image and the second image are the same.

4. The apparatus of claim 1, wherein the output module is further configured to alternately output the first image and the second image based on 3D content of a still image, and to repetitively output the 2D content images based on 2D content of a still image.

5. The apparatus of claim 1, wherein the output module is further configured to alternately output the first image and the second image based on 3D content of a moving image, and to repetitively output the 2D content images based on 2D content of a moving image.

6. The apparatus of claim 1, wherein the output module is further configured to output the 3D content and the 2D content based on capturing time information of the 3D content and the 2D content.

7. The apparatus of claim 1, further comprising a display configured to display images comprising a parallax based on the first image and the second image output under the control of the output module, and to display parallax-free images based on the 2D content images.

8. A video output method comprising:
displaying images having a parallax by alternately outputting a first image and a second image at image output timings based on 3D content, and repetitively outputting 2D content images at the image output timings based on 2D content; and
transmitting, to 3D image glasses configured to open and close a right-eye shutter and a left-eye shutter, timing control signals indicative of open and close timings of the right-eye shutter and the left-eye shutter which synchronize the open and close timings with the image output timings, for both the 2D content and the 3D content.
